(19) United States
(12) Patent Application Publication
(10) Pub. No.: US 2004/0103191 A1
(43) Pub. Date: May 27, 2004

(54) Method and system for real-time updating of available network service access in a communication network

(76) Inventor: Johan Larsson, Karlskrona (SE)

Correspondence Address: JENKENS & GILCHRIST, PC, 1445 ROSS AVENUE, SUITE 3200, DALLAS, TX, 75202, US

(21) Appl. No.: 10/450,965

(22) PCT Filed: Dec. 18, 2001
(86) PCT No.: PCT/SE01/02812

(30) Foreign Application Priority Data
Dec. 18, 2000 (SE) 0004672-2

(51) Int. Cl. G06F 15/173

(52) U.S. Cl. 709/224; 709/226

(57) ABSTRACT

A data processing system for use in an electronic communication network providing communication services for station (3) connected to the network, comprising computer processing means (4) for processing data, and storage means connected to said computer processing means for storing data on a storage medium, wherein the computer processing means comprises first means for initializing a first parameter with a network service access starting value and a second parameter with a consumption value in the storage means, said values being associated with a first station connected to the network, second means for descreasing the first parameter with an amount corresponding to a certain usage of any of said communication services, and third means for increasing said second parameter with the same amound.

### FIELD OF THE INVENTION

The present invention relates to a method and system for use in an electronic communications network providing communication services for stations connected to the network, and more particularly to a method and system providing real-time updating of available network service access for stations connected to the network.

### DESCRIPTION OF THE PRIOR ART

Today's mobile telephone communications networks, public switched telecommunications networks (PSTN), ISDN, ATM, Internet etc. provide many different more or less sophisticated tele and data communications services for users and providers, regional as well as world-wide. The demands for increased benefit of the network operator, the service provider, and the service subscriber have brought forth the concept of Intelligent Network (IN). An Intelligent Network is a telecommunications concept that meets the market demand, from network operators and service providers, for advanced services within the existing telephony network. Except for making regular phone calls the IN networks provide centralised intelligent network services such as voice mail, sending and receiving text messages, sending and receiving fax and data calls, calling line identification and calling line identification restriction, universal access number, phone number portability etc., and distributed services such as re-dialling, diverting incoming calls, call waiting, call on hold, conference calls etc. Different network providers offer different sets of services including both charged and free services.

Billing for usage of the networks and their associated services is achieved by means of a payment mechanism. Both post-paid and pre-paid systems are used. In prior art pre-paid systems it is common practice to load an account with money and then deduct the account balance due to subscriber usage. For an ongoing call, the account balance is decreased step by step until it is zero, resulting in that the call is cut off and no charged activity is allowed until the account has been refilled.

The rating of calls is based on a number of parameters, including A-number, B-number, date, time etc. These parameters and additional information associated with the subscriber's account are used to decide the rate of a call. In post-paid systems the end-user or subscriber is billed periodically, for example once every month, and the call information is rated during the month or at the end of the month. However, different discounting schemes are applicable first after all calls have been rated. Then, the discount is given to the subscriber at the end of the month for all charges incurred during the month (period).

### SUMMARY OF THE INVENTION

It is an object of the present invention to provide an improved system for use in an electronic communication network, providing real-time updating of available network service access and changing of communication service level for subscribers in the network.

This object is achieved by a data processing system comprising computer processing means for processing data, and storage means for storing data on a storage medium, wherein the computer processing means is configured to initialise a first parameter with a network service access starting value and a second parameter with a consumption value in the storage means, decrease the first parameter with an amount corresponding to a certain usage of any of the communication services, and increase the second parameter with the same amount.

A more specific object of the invention is to provide a system, which updates the available network service access and/or changes the communication service level for subscribers consuming a certain amount of network service access.

This is achieved by the data processing system according to the invention, wherein the computer processing means is further configured to initialise a third parameter with a threshold value in the storage means, compare the consumption value with said threshold value, and change the service level for a subscriber depending on the comparing result.

Another object of the invention is to provide an improved method for real-time updating of available network service access and network communication services on different levels for subscribers in a communications network.

This object of the invention is achieved by a method for updating of available network service access and network communication services for a subscriber in a communications network, wherein a network service access parameter is decreased with an amount corresponding to the usage of the network service access, wherein a consumption parameter is increased, a threshold parameter is compared with the consumption parameter at a predetermined event, and depending on the comparing result, the service level for a subscriber is changed.

An advantage of the present invention is the real-time updating of available network service access depending on a certain usage of communication services.

### BRIEF DESCRIPTION OF THE DRAWINGS

In order to explain the invention in more detail and the advantages and features of the invention a preferred embodiment will be described in detail below, reference being made to the accompanying drawings, in which

FIG. 1A is a schematical view of a cellular mobile telephone network, comprising a system according to the invention for real-time updating of available network service access for stations connected to the network,

FIG. 1B is a schematical view of an intelligent network implementation of the network in FIG 1A,

FIG. 2 is a flow chart of the call flow for an originating charged call in a system according to the invention, and

FIG. 3 is a flow chart of a threshold comparison in the system according to the invention.

### DETAILED DESCRIPTION OF THE INVENTION

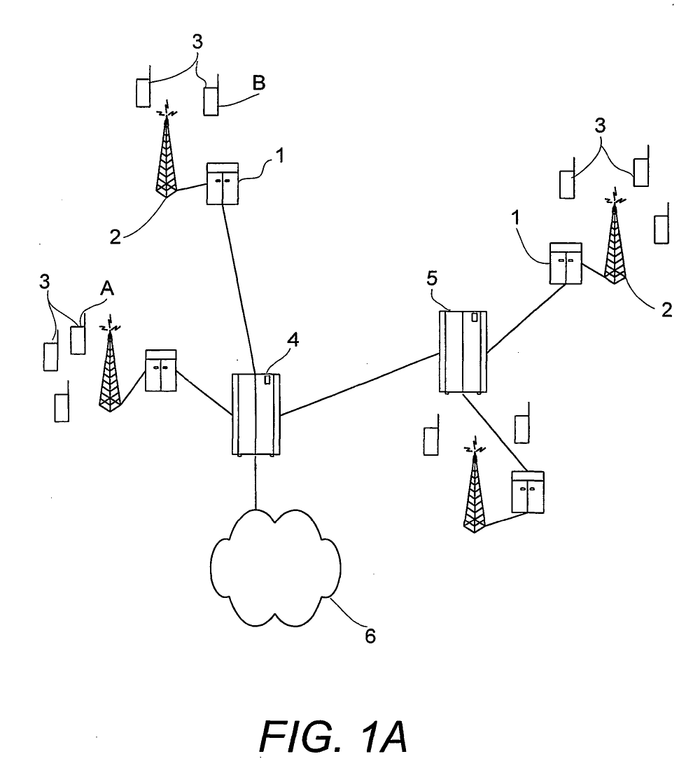

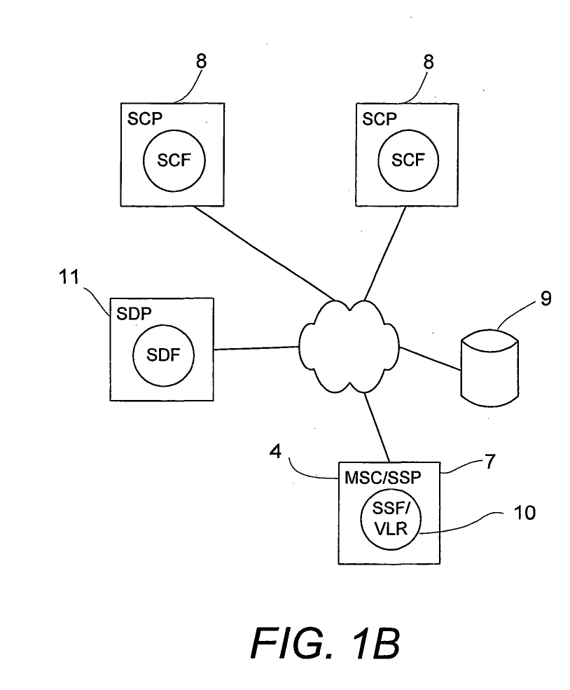

An example of a cellular mobile telephone network architecture is shown in FIG 1A. This is a service providing network such as an intelligent network (IN) providing real-time updating of available network service access for subscribers in the network according to the invention.

Cellular telephone service involves the subdivision of a service area into a number of smaller cells. Each cell requires a base station (BS) 1 and an antenna 2. The base station 1 performs the switching function as well as the tracking of mobile telephone users. A gateway mobile services switching center (GMSC) 4 or only mobile services switching center (MSC) 5 provides the network with specific data about individual mobile phones 1 and operate as an interface to the public switched network (PSTN) 6. The (G)MSC 4 or 5 comprises a data processing system, including a computer processor for processing data, and storage means connected to the computer processor for storing data on a storage medium.

Cellular systems are based on both analogue and digital transmission. Digital cellular systems provide the best quality with the least amount of bandwidth. Different kinds of principles such as TDMA or CDMA technologies are used for digital cellular systems.

Additionally, the intelligent network has a signalling network, which performs message switching between network elements. In this embodiment of the invention, a specific type of signalling protocol, signalling system 7 (SS7), is used for the exchange of information messages and carries many types of information elements, which are useful for intelligent network services. However, SS7 is only an example and the signalling protocol can be another protocol such as the Internet Protocol (IP).

Referring to FIG 1B, there is shown a schematical view of an intelligent network implementation of the network in FIG 1A including a service switching point (SSP) 7 located in the (G)MSC 4. The SSP 7 detects events indicating a call requiring IN and after this triggering, the SSP 7 suspends call processing and starts a series of transactions with a service control point (SCP) 8. The SCP 8 is a real-time database system that, based on a query from the SSP 7, performs subscriber- or application-specific service logic, controlling the call set-up and call flow. A home location register (HLR) 9 stores the identity and user data of all the subscribers belonging to the area of the related (G)MSC 4. The HLR 9 provides the (G)MSC 4 with the necessary subscriber data when a call is coming from a public switched network (PSTN) 6, an ISDN network, Internet etc. A visitors location register (VLR) lo contains relevant data of all mobiles currently located in a serving (G)MSC 4. The VLR 10 has to support the (G)MSC 4 during call establishment when a call is coming from a mobile telephone 1. A service data point (SDP) 11 is a database containing data service class data and tariff data. Rating and charging analysis is also handled in the SDP 11, in this embodiment.

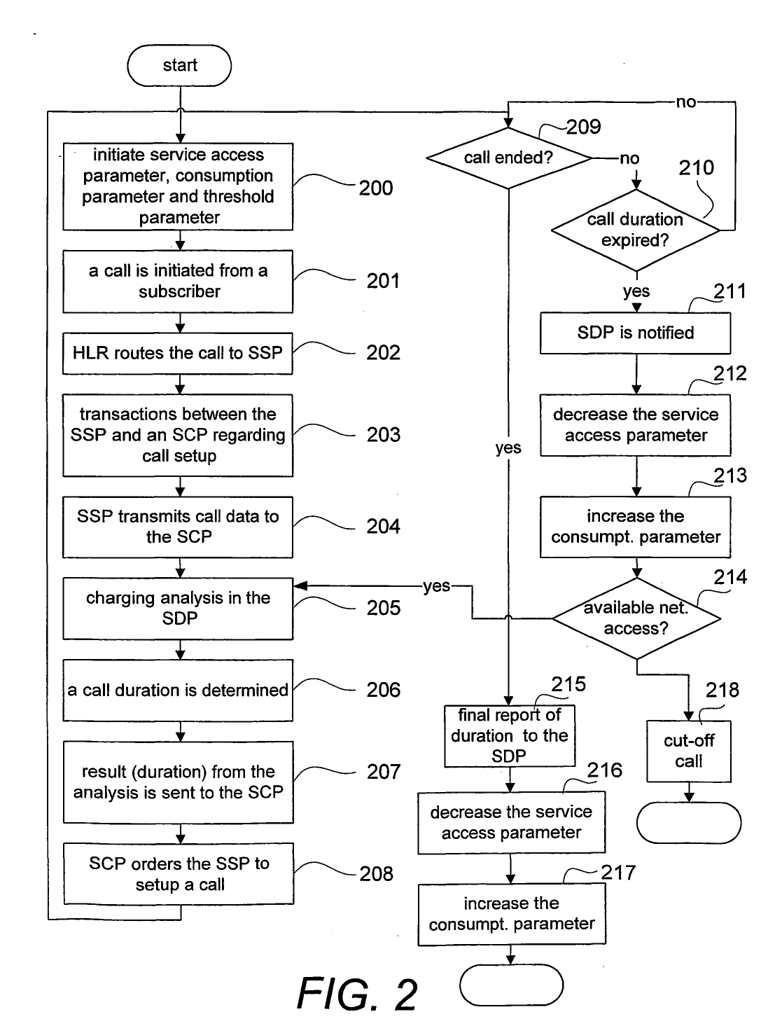

Referring to FIG. 2 in the drawings there is shown a flow chart of the call flow of an originating charged call in a system with real-time updating of available network service access for mobile phones or stations connected to the network according to the invention.

Before a mobile telephone user can make a phone call or use another service provided by the network he/she has to be a “subscriber”. In the system according to the invention, at least one network service access parameter and one consumption parameter, associated with user or subscriber using for example a mobile phone, are created in a service data function in the SDP 11. The first parameter is initialised with a network service access starting value and the second parameter is initialised with a consumption value in said storage means in step 200. The parameter values, i.e network service access starting value and the consumption value could be either time based, volume based, event based, or a combination thereof.

A call is initiated from a subscriber using a mobile phone 1 in step 201. An originating IN category key (OICK) in the HLR makes the MSC to route the call to the SSP 7 to be handled by a service switching function (SSF) in step 202. The SSP starts a series of transactions regarding call set-up and call flow with the SCP for collection of data related to the call in step 203. The collected data is sent to the SDP 11 in step 204 for service scenario control and charging analysis in step 205. The service scenario implies different levels of services available for subscribers such as access to charged and/or non-charged calls. During the charging analysis a tariff is determined for the charging of the current call, which is based on different parameters depending on the particular traffic case.

In this embodiment of the invention tariff data is organised in a tariff structure, including a decision tree with several conditions and tariffs. A single call may include several conditions and tariffs, allowing tariff switching during the ongoing call.

A certain amount of available network service access, which is based on the current tariff, is reserved for the current call, and a duration is determined for the call in step 206 and the result is send to the SCP 8 in step 207. The SCP 8 sends an order to the SSP 7 to set-up and to supervise the call based on the determined call duration in step 208.

The duration of the ongoing call is supervised and “the call” reports when it has ended in step 209. If the call is still proceeding it is checked in step 210 if the call duration is equal to or greater than the determined call duration. If the resulting comparison is false the flow again proceeds with step 209. However, if the resulting comparison is true the SSP 7 notifies the SCP 8 and the SCP 8 notifies the SDP 11 in step 211. Next, the network service access parameter and the consumption parameter are updated. The first parameter is decreased with an amount corresponding to the usage of the communication service, the call connection time in this embodiment, or short message service (SMS) or other service usage in alternative embodiments of the invention, in step 212. Correspondingly, the second parameter is increased with the same amount in step 213.

By a request from the SCP 8 it is determined in the SDP if there is still available network service access for the particular subscriber, i.e the first parameter is not empty. This determination is performed in step 214 and the call flow proceeds with a new charging analysis in step 205.

A new amount of available network service access is reserved for the current call, and a new duration is calculated for the call in step 206 and the result is send to the SCP 8 in step 207. The SCP 8 orders the SSP 7 to supervise the call based on the determined call duration in step 208.

The duration of the ongoing call is supervised and “the call” reports when it has ended in step 209. If the resulting comparison is true the call has ended and the SSP 7 notifies the SCP 8, and a final report, containing information of the total duration of the call as well as the last period, is sent from the SCP 8 to the SDP 11 in step 215. Of course, a final decrease of the first parameter with an amount corresponding to the usage of the communication service during the last period is performed in step 216, as well as a final increase of the second parameter in step 217.

In the system according to the invention, a prepaid system in the embodiment, each charged call or other service is supervised in real time and the available network service access value can not be overdrawn. Consequently, a subscriber trying to make a call when there is no available network service access, i.e the first parameter is empty, and the call is not established. In a case when a call is ongoing and it is determined during the charging analysis that all available network service access is consumed, the call is cut-off in step 218.

A third parameter or threshold parameter is created and initiated with a threshold value in the storage medium, for example at the same time as the initialisation of the first and second parameter in step 200.

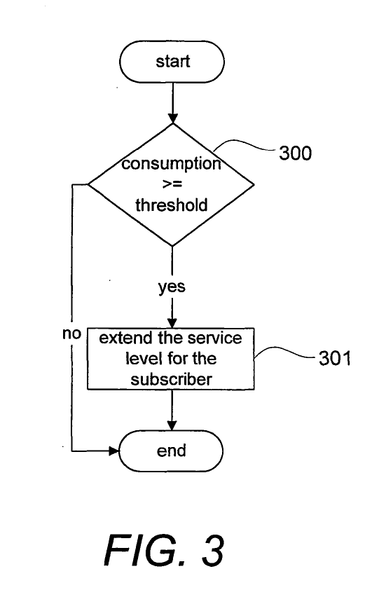

With reference to FIG. 3, a comparison between the threshold parameter and the consumption parameter is performed at intervals and/or at particular events in step 300, for example every time the consumption value is increased in step 211 or 216. Depending on the resulting comparison certain measures are taken by the system in step 301. For example, if the consumption value equals or exceeds the threshold value, it causes an extended service level to the user or the available network access parameter is increased with a certain amount. Another level causes a restricted service level, such as barring of international calls for the purpose of credit control.

In this embodiment the network operator has a toolbox with functions/services, i.e different service levels, which are activated when the consumption value reaches the threshold value.

Functions/services activated by the system, i.e changing of the service level for a subscriber, when the consumption value reaches the threshold value are: volume based discounting, i.e a change of tariffs or replacement of the tariff plan for the subscriber, bonus programs, change of service class, change of service dates, change of the consumption parameter value, extension of a service period, and/or restricted service etc. Further, it is possible to reset the consumption parameter, for example at refill, after a certain time, when the threshold is increased, or when the network service access parameter passes a threshold value. Of course, the service level can also be changed at reset.

A single or multiple functions/services, including reset of the threshold value, may be activated simultaneously.

It should be apparent that the present invention provides an improved method and system for use in an electronic communication network, providing real-time updating of available network service access for stations connected to the network, and necessary functionality for a pre/post-paid system, that fully satisfies the aims and advantages set forth above. Although the invention has been described in conjunction with a specific embodiment thereof, this invention is susceptible of embodiments in different forms, with the understanding that the present disclosure is to be considered as an exemplification of the principles of the invention and is not intended to limit the invention to the specific embodiment illustrated.

For example, the usage of the communication services can be either time based, as in the present embodiment described, or event based, or volume based, such as with short message service (SMS), file transfer/download or other service usage, independent of the used time, in alternative embodiments of the invention.

In an alternative embodiment of the invention an unstructured supplementary service data (USSD)/SMS/email message functionality etc. is provided, wherein a subscriber gets information about available network services access on the mobile telephone display. Although the method is described in conjunction with a mobile telephone call in an intelligent network the method is applicable on any communication session and other communication services in other kind of networks. For example, the method and system according to the invention are applicable in other mobile telephone networks, public switched telecommunications networks (PSTN), ISDN, ATM, Internet etc., which provide many different more or less sophisticated tele and data communications services for users and providers. Such networks can provide distributed services such as re-dialling, diverting incoming calls, call waiting, call on hold, conference calls etc., and centralised intelligent network services such as voice mail, sending and receiving text messages, sending and receiving fax and data calls, calling line identification and calling line identification restriction, universal access number, phone number portability, e-commerce transaction etc. Some or all of these services and other services can be chargeable and, when they are used, resulting in a change of the service level of a station, or a subscriber(s), or another user associated with the network provider, as described above. Different network providers offer different sets of services including both charged and free services.

Further, the real-time updating of available network service access and changing of communication service level for stations connected to the network can be implemented as a traditionally designed service, e.g. new function blocks, etc. in the MSCs or switches.

1. A data processing system for use in an electronic communication network providing communication services on different levels for subscribers (3), comprising computer processing means (4) for processing data, and storage means connected to said computer processing means for storing data on a storage medium, characterised in that said computer processing means is configured to initialise a first parameter with a network service access starting value and a second parameter with a consumption value in said storage means, decrease said first parameter with an amount corresponding to a certain usage of any of said communication services, and increase said second parameter with the same amount.

2. A data processing system according to claim 1, characterised in that said computer processing means is further configured to initialise a third parameter with a threshold value in said storage means, compare said consumption value with said threshold value, and change the service level for a subscriber depending on the comparing result.

3. A data processing system according to claim 1, characterised in that said computer processing means is further configured to update available network service access and/or network communication services on different levels for subscribers (3) in a communications network in real-time.

4. A data processing system according to claim 1, characterised in that said computer processing means is further configured to initialise a number of instances of said first, second and third parameters, wherein each parameter gets a network service access starting value for a separate or a group of communication services.

5. A method for updating of available network service access and/or network communication services for a subscriber in a communications network, wherein a network service access parameter is decreased with an amount corresponding to the usage of the network service access (209,210,211,212), characterised by the further steps of:
increasing a consumption parameter,
at a predetermined event, comparing a threshold parameter with the consumption parameter, and
depending on the comparing result, changing the service level for a subscriber (A).

6. A method according to claim 5, characterised in that the consumption parameter is associated with a particular subscriber (A).

7. A method according to claim 5, characterised in that the threshold parameter is associated with a particular subscriber (A).

8. A method according to claim 5, characterised in that the threshold parameter is associated with another subscriber (B).

9. A method according to claim 5, characterised in that the threshold parameter is a common parameter associated with a number of subscribers (A,B).

10. A method according to claim 5, characterised in that the service level is changed for a particular subscriber (A).

11. A method according to claim 5, characterised in that the service level is changed for another subscriber (B).

12. A method according to claim 5, characterised in that the service level is changed for a number of subscribers (A,B).

13. A method according to claim 5, characterised in that the consumption parameter is reset at refill, after a certain time, when the network service access parameter passes a threshold value.

14. A method according to claim 13, characterised in that the service level is changed when the consumption parameter is reset.
